(19) United States
(12) Patent Application Publication
(10) Pub. No.: US 2016/0073609 A1
(43) Pub. Date: Mar. 17, 2016

(54) Feeder for Animals

(71) Applicant: Crystal Spring Colony Farms Ltd., Ste. Agathe (CA)

(72) Inventor: Jonathan Kleinsasser, Ste. Agathe (CA)

(21) Appl. No.: 14/488,811

(22) Filed: Sep. 17, 2014

(51) Int. Cl. A01K 5/01; A01K 9/00; A01K 7/02

(52) U.S. Cl. CPC A01K 5/01; A01K 7/02; A01K 9/005

(57) ABSTRACT

A feeder for feeding animals has a trough with two opposed outwardly inclined front walls over which the animals can reach for taking feed from the trough and a feed hopper for discharging feed downwardly onto a shelf above the trough. Water is supplied into the trough through a pipe along the trough underneath the shelf with a series of animal actuated nipples so that the animals may take the feed dry on the shelf or wet from the trough. A valve is provided at one end wall through which the water supply to the pipe passes, the valve having a plurality of separate orifices of different flow area and a manually operable control for selecting one of the plurality of orifices for passage of the water from the supply to the pipe.

This invention relates to a feeder for animals, of the type for feeding dry feed in particulate form, which includes a substantially horizontal surface beneath a hopper so that the feed from the hopper is discharged onto the surface from which the feed can be transferred by the animal to a trough for mixing with water.

### BACKGROUND OF THE INVENTION

An example of a feeder of this type is shown in U.S. Pat. No. 4,660,508 (Kleinsasser) and this type of feeder has become very successful and is widely known as a wet/dry feeder in view of the fact that the animal can take dry feed from the shelf of the feeder or can apply water into feed discharged into the trough to take the feed in the trough in wet condition.

The intention is that the animals themselves control the amount of water supply by providing nipples in the trough which can be actuated by the animal to discharge water into the trough to mix with the feed. One advantage of this type of feeder is that the animals can mix the feed to the consistency they prefer so that they are encouraged to eat as much as possible by ensuring that they are not discouraged from eating by the feed being too dry or too wet. It has been found that this type of feeder has considerable increase in weight gain for the animals over conventional dry feeders.

Feeders of this type can either be double sided that is the feeder has two sides each of which can be accessed by a different set of animals so that generally the feeder is placed in a fence line to supply feed to animals in two separate panic. Other type of feeders are however single sided so that they have generally a vertical rear wall with the trough presented forwardly of that rear wall and the animals accessing the feeder only from the trough side of the rear wall.

In U.S. Pat. No. 5,640,926 of the present inventor issued Jun. 24, 1997 is disclosed a feeder of the above type. In this feeder, the height of the shelf from the trough is adjustable so as to accommodate a change in size of the animals from a smaller size up to a larger size as the animals grow.

In U.S. Pat. No. 5,967,083 (Kleinsasser) issued Oct. 19, 1999 is disclosed a feeder of the above type. In this feeder, the height of the side wall of the trough from the base of the trough is adjustable so as to accommodate a change in size of the animals from a smaller size up to a larger size as the animals grow.

Feeders of this type are designed and manufactured for hogs from weanlings up to finishers and the above adjustable types can be used in some circumstances to accommodate growth or different feeders of fixed dimensions for different sizes of animal may be provided.

One problem which has existed since the invention of this type of feeder is that of controlling the amount of water which is released by the animals into the trough. Even with older experienced animals the amount of water discharged by them varies and may be excessive in some cases leading to a mess to be cleaned up. If the amount of water is insufficient, this may restrict the amount of feed take up by the animals leading to reduced growth rates. In particular, very young weanlings have a tendency to play with or activate the water nipples due to their recent suckling and hence they release too much water into the trough so that the feeder becomes overwhelmed with consequent blocking of the feed supply to the shelf. Of course the presence of the excess water also inhibits the feed intake of the animals.

Many attempts have been made to overcome this problem by various techniques including controlling the pressure of the water supply to the nipples so that the amount dispensed is reduced.

In U.S. Pat. No. 7,832,356 (Kleinsasser) issued Nov. 16, 2010 is disclosed an arrangement of this type in which water is normally supplied through a first water supply line which has a series of nipples controlled by the animals. However, while the weanlings are very young the first water supply line is closed off and water is supplied from a second supply line which is managed by a timer.

In U.S. Pat. No. 5,255,632 (Thomas) issued Oct. 26, 1992 is disclosed an arrangement of this type in which the animals are free to operate as the nipples at their own volition but an additional sensor is provided in the trough which acts to control a valve in the supply line to prevent the water level exceeding a predetermined maximum.

Up to now all of these attempts have been either completely unsuccessful or less than optimum so that an improved solution is required.

### SUMMARY OF THE INVENTION

It is one object of the present invention to provide an improved feeder for animals of this general type which prevents the animals from introducing excess water levels within the trough while allowing free access to the water dispensing nipples.

According to a first aspect of the invention there is provided a feeder for animals comprising:

an elongate trough having a base and a sidewall for receiving and containing feed and water and arranged such that the head of the animal can reach over an upper front edge of the sidewall to the base for eating the feed and water;

an elongate shelf providing a substantially horizontal surface for receiving feed;

the horizontal surface of said shelf being arranged at a height above and rearwardly of said front edge so as to allow access by the head of the animal to said shelf for direct feeding therefrom, and between said shelf and said front edge to the base;

a hopper for continually depositing feed onto said shelf arranged such that deposited feed on the shelf remains on said shelf but can be removed to the trough by the animal;

a water supply for the feeder for dispensing water into the trough including a pipe supplying water to the feeder;

at least one nipple connected to the pipe in the feeder actuable by the animals for control by the animals of the dispensing of the water into the trough arranged such that said at least one nipple avoids dispensing water onto the shelf;

a valve through which the water supply to the pipe passes, the valve having a plurality of separate orifices of different flow area and a manually operable control for selecting one of the plurality of orifices for passage of the water from the supply to the pipe.

Preferably the nipples on the pipe are arranged beneath the shelf and arranged to direct water downwardly therefrom into the trough.

Preferably the nipples are arranged such that the animal is not intended to drink directly from it.

Preferably there is a row of nipples along the pipe within the feeder so as to discharge water from the hose into the trough.

Preferably the water supply from the valve is connected to one or more additional feeders.

Preferably the valve includes an off position.

Preferably the valve comprises a housing having a cylindrical valve surface connected to a water inlet at one side and a water outlet at an opposed side and a valve member arranged for rotation in the cylindrical valve surface and wherein the valve member has a part cylindrical wall defining an inner chamber communicating with the water inlet with the orifices arranged to pass radially through the part cylindrical wall at angularly spaced positions therein.

Preferably the feeder has an end wall forming an end of the hopper and wherein the valve is located at the end wall connecting to the pipe which extends along the feeder underneath the shelf.

The long-standing problem herein by which the animals can over feed the water into the trough by repeated or extended operation of the water supply nipples is solved in a manner which is totally surprising. This is done without additional controls to actually measure the amount of water in the trough, which only partly solves the problem since even that amount of water allowed up to the measure level is not desirable. The solution reduces the flow rate by passing the water though an orifice but allows the user to tailor the orifice area to be used by selecting one of the plurality of orifices. This is surprising in that reducing the low rate does not in fact limit the maximum water which can be introduced into the trough should the animals act to run the nipples sufficiently long to supply excess water. However it has been found that selecting the reduced rate of supply of water in practice causes the animals themselves to limit the amount supplied into the trough.

The orifice to be used can be selected by the operator by simply measuring an amount of water dispensed by holding the nipple activated over a set time. Depending on the amount dispensed, the orifice can be increased or decreased in size to best match the required flow rate. The amount dispensed can change depending on water pressure in the barn or local water pressure at certain feeders and hence the arrangement herein takes a novel approach by controlling the orifice size rather than trying to manage water pressure by regulators or the like.

### BRIEF DESCRIPTION OF THE DRAWINGS

Embodiments of the invention will now be described in conjunction with the accompanying drawings in which:

FIG. 1 is an isometric view of an embodiment of feeder according to the present invention.

FIG. 2 is an isometric view of the water line of the feeder of FIG. 1.

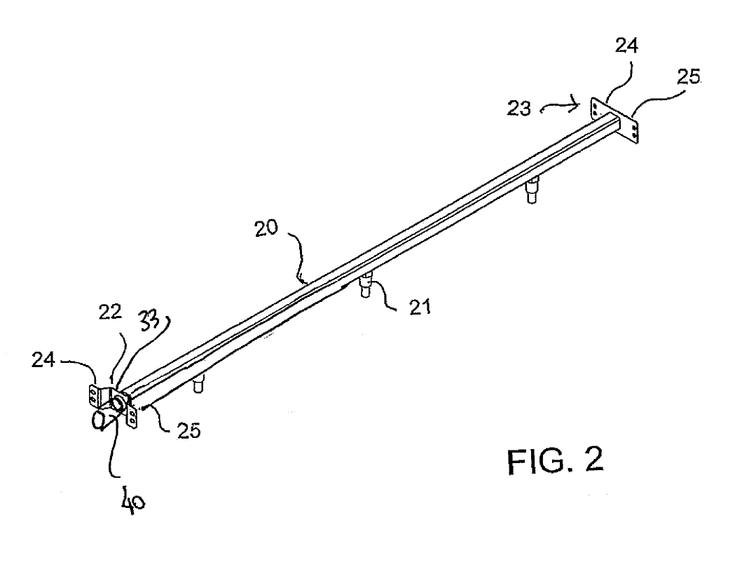

FIG. 3 is a side elevational view of the end of the water line of FIG. 2 showing the valve for controlling the water flow in the pipe.

FIG. 4 is a cross-sectional view along the lines 4-4 of FIG. 3.

### DETAILED DESCRIPTION

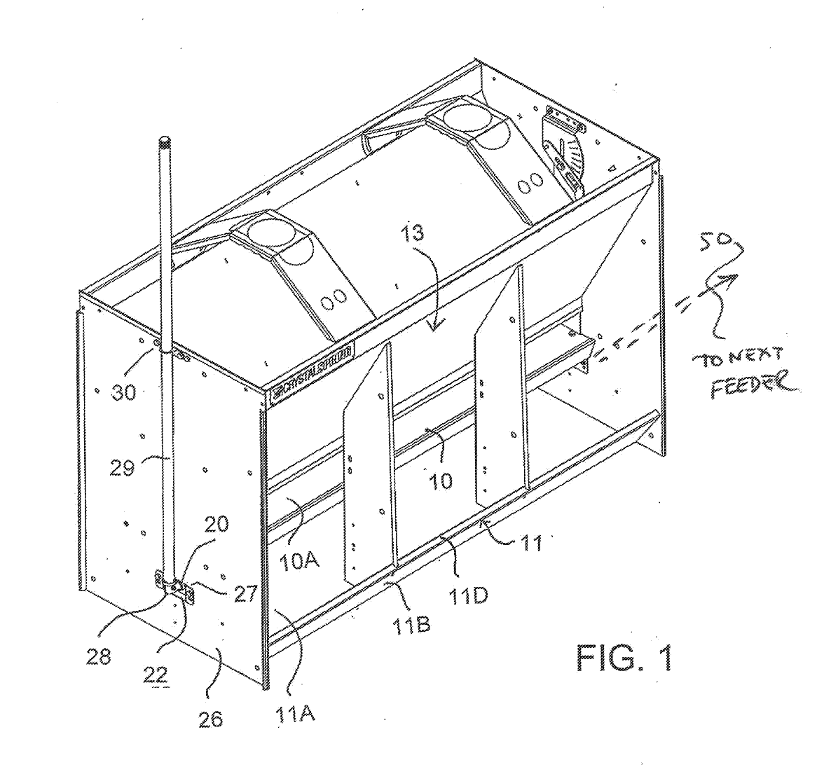

The embodiment shown in FIG. 1 is of the type shown a wet and dry feeder or shelf-type feeder in which the feed is deposited onto a shelf 10 positioned above a trough 11 so that the feed is available in dry condition on the shelf 10 accessible by the animal and can be moved by the animal to the trough for mixing with water for taking in wet condition. A hopper 13 is located above the shelf for depositing the feed on the shelf. This type of feeder is well known and further details are shown in the above three patents of the present inventor, the disclosures of which are incorporated herein by reference.

The feeder can be double sided or single sided as is well known. The feeder can be adjustable as described in the second and third above patents or may be a fixed size feeder as disclosed in the first above patent.

Beneath the shelf is a first water line 20 with a series of animal controlled nipples 21 at spaced positions along the length of the water line which can be actuated by the animal to discharge water into the trough from the first water line. The nipples can be bite nipples which are not intended to drink from but discharge into the trough or they may be drinking nipples. When actuated water runs freely from the supply line 20 into the trough 11.

The water supply line 20 comprises an elongate tubular duct of square cross-section with the nipples attached onto a bottom face of the square tube. At each end of the tube is provided a respective bracket 22, 23 in the form of a plate with two side wings 24, 25 which bolt to a respective end wall 26 of the feeder.

As shown in previous examples of the feeder of the present Applicants, the end walls 26 are parallel and sand vertically so as to form ends of the hopper 13 and the trough 11. Each end wall has a hole 27 through which the end of the water line projects to allow the attachment of the bracket to the exterior of the end wall.

Water is supplied to the water line by a pipe 29 connected at the bracket 22 to the line 20 by an elbow 28 connected by a thread 28A. The pipe 29 extends vertically to an over-head connector of a water supply (not shown). The pipe is held vertical by a bracket 30 at the top of the wall 26 and by the bracket 22.

The water line 20 is connected to the bracket 22 by a fitting 31 which also connects to the elbow 28. The fitting 31 is of circular cross-section and inserts into an end of the square tube forming the water line.

The bracket 22 has a center web 33 to which the fitting 31 is attached with the web 33 parallel to and recessed from the wings 24, 25 so that the fitting 31 is protected in the recessed center section of the bracket to prevent damage by impact.

The arrangement herein therefore provides an apparatus and method of feeding animals where the feeder includes the elongate trough 11 having a base 11A and a sidewall 11B for receiving and containing feed and water and arranged such that the head of the animal can reach over an upper front edge 11D of the sidewall 11B to the base 11A for eating the feed and water.

The horizontal surface 10A of said shelf being arranged at a height above and rearwardly of the front edge so as to allow access by the head of the animal to the shelf for direct feeding therefrom, and between the shelf and the front edge to the base.

The hopper is arranged for continually depositing feed onto the shelf arranged such that deposited feed on the shelf remains on the shelf but can be removed to the trough by the animal.

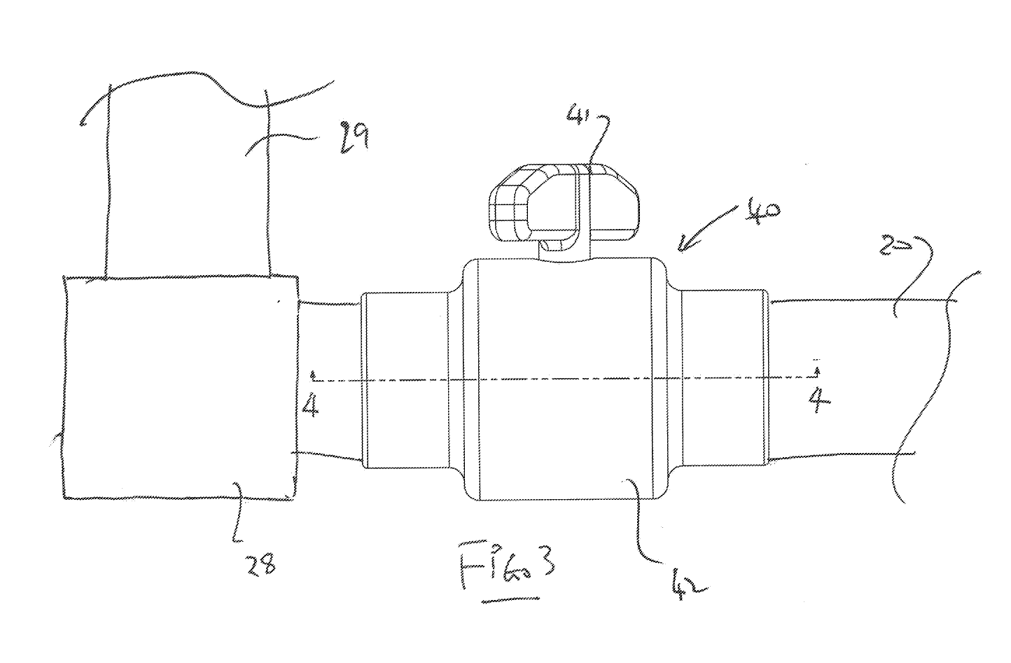

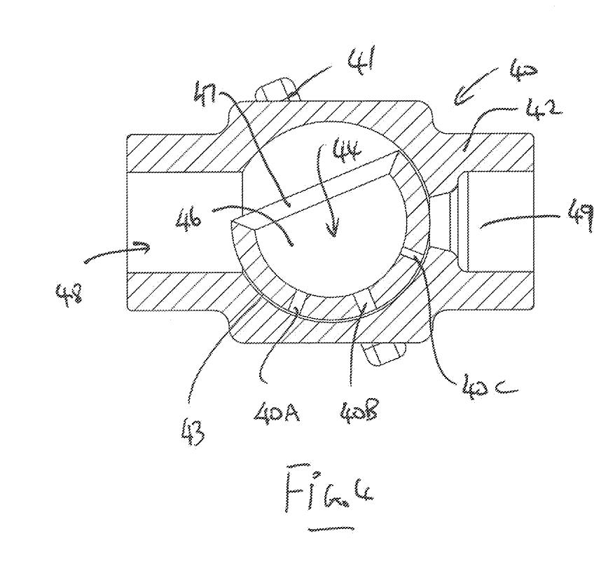

The water supply is managed and controlled by a valve 40 through which the water supply to the pipe passes, the valve 40 being shown in FIGS. 3 and 4 having a plurality of separate orifices 40A, 40B, 40C of different flow area and a manually operable control 41 for selecting one of the plurality of orifices for passage of the water from the supply to the pipe.

The valve comprises a housing 42 connected at one end to the water supply from the elbow 28 and at the other end to the pipe 20. The housing defines in the inside a cylindrical valve surface 43 connected to the water inlet at one side and the water outlet at the other side.

The valve further includes a valve member 44 arranged for rotation by the manually operable lever 41 in the cylindrical valve surface 43. The valve member 44 has a part cylindrical wall 45 which rotates around inside the surface 43.

The wall 45 has an inner chamber 46 communicating though an opening 47 in the wall 45 with the water inlet 48. The orifices 40A, 40B and 40C are drilled radially to pass through the part cylindrical wall 43 at angularly spaced positions around the wall to communicate water to the outlet 49.

As shown in FIG. 4, the valve is in a closed position in that the orifices are spaced from the outlet 49 so that the wall 45 closes the outlet 49. The valve can be operated from the off position shown by rotating the handle 41 through marked positions to select one of the orifices to communicate with the outlet 49.

1. A feeder for animals comprising:
an elongate trough having a base and a sidewall for receiving and containing feed and water and arranged such that the head of the animal can reach over an upper front edge of the sidewall to the base for eating the feed and water;
an elongate shelf providing a substantially horizontal surface for receiving feed;
the horizontal surface of said shelf being arranged at a height above and rearwardly of said front edge so as to allow access by the head of the animal to said shelf for direct feeding therefrom, and between said shelf and said front edge to the base;
a hopper for continually depositing feed onto said shelf arranged such that deposited feed on the shelf remains on said shelf but can be removed to the trough by the animal;
a water supply for the feeder for dispensing water into the trough including a pipe supplying water to the feeder;
at least one nipple connected to the pipe in the feeder actuable by the animals for control by the animals of the dispensing of the water into the trough arranged such that said at least one nipple avoids dispensing water onto the shelf;
a valve through which the water supply to the pipe passes, the valve having a plurality of separate orifices of different flow area and a manually operable control for selecting one of the plurality of orifices for passage of the water from the supply to the pipe.

2. The feeder according to claim 1 wherein the at least one nipple of the pipe is arranged beneath the shelf and arranged to direct water downwardly therefrom into the trough.

3. The feeder according to claim 1 wherein said at least one nipple is arranged such that the animal is not intended to drink directly from it.

4. The feeder according to claim 1 wherein there is provided a row of nipples along the pipe within the feeder so as to discharge water from the hose into the trough.

5. The feeder according to claim 1 wherein the water supply from the valve is connected to one or more additional feeders.

6. The feeder according to claim 1 wherein the valve includes an off position.

7. The feeder according to claim 1 wherein the valve comprises a housing having a cylindrical valve surface connected to a water inlet at one side and a water outlet at an opposed side and a valve member arranged for rotation in the cylindrical valve surface and wherein the valve member has a part cylindrical wall defining an inner chamber communicating with the water inlet with the orifices arranged to pass radially through the part cylindrical wall at angularly spaced positions therein.

8. The feeder according to claim 1 wherein the feeder has an end wall forming an end of the hopper and wherein the valve is located at the end wall connecting to the pipe which extends along the feeder underneath the shelf.
